(19) United States
(12) Patent Application Publication
(10) Pub. No.: US 2021/0107419 A1
(43) Pub. Date: Apr. 15, 2021

(54) ELECTRICAL ASSEMBLY

(71) Applicant: Lear Corporation, Southfield, MI (US)

(72) Inventors: Raúl Ricart, Valls (ES); Antoni Ferré Fàbregas, Valls (ES)

(21) Appl. No.: 16/597,187

(22) Filed: Oct. 9, 2019

(51) Int. Cl. B60R 21/01; B60R 16/023

(52) U.S. Cl. CPC B60R 21/01; B60R 16/0231; B60R 2021/01034; B60R 21/017; B60R 2021/01211; B60R 2021/01272; B60R 2021/01286; B60R 2021/01088

(57) ABSTRACT

An electrical assembly includes a first controller, a track assembly, and/or a support assembly configured for selective connection with the track assembly. The support assembly may include a second controller, a sensor, and/or a plurality of safety devices. The first controller may be configured to provide crash information to the second controller. The second controller may be configured control the plurality of safety devices according to the crash information and information from the sensor. The first controller may be connected to the second controller via at least two wireless connections. The at least two wireless connections may include at least one of induction coupling, magnetic field generation and detection, and light transmission. The first controller may be configured to provide the crash information to the second controller only via one or more wireless connections.

### TECHNICAL FIELD

The present disclosure generally relates to electrical assemblies including electrical assemblies that may be used in connection with vehicles.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

Some electrical assemblies may be relatively complex and/or may not provide sufficient functionality. Some electrical assemblies may not be configured for use with vehicle seats or removable or reconfigurable seats, such as vehicle seats that include airbags. With some electrical assemblies, it may be desirable to communicate information between the one or more components of the electrical assembly. In some circumstances, the number of physical connections via which to communicate such information may be limited.

There is a desire for solutions/options that minimize or eliminate one or more challenges or shortcomings of electrical assemblies. The foregoing discussion is intended only to illustrate examples of the present field and is not a disavowal of scope.

### SUMMARY

In embodiments, an electrical assembly may include a first controller, a track assembly, and/or a support assembly configured for selective connection with the track assembly. The support assembly may include a second controller, a sensor, and/or a plurality of safety devices. The first controller may be configured to provide crash information to the second controller. The second controller may be configured control the plurality of safety devices according to the crash information and information from the sensor. The first controller may be connected to the second controller via at least two wireless connections. The at least two wireless connections may include at least one of induction coupling, magnetic field generation and detection, and light transmission. The first controller may be configured to provide the crash information to the second controller only via one or more wireless connections.

With examples, an electrical assembly may include a second support assembly configured for selective connection with the track assembly. The second support assembly may include a third controller and/or a plurality of safety devices. The first controller may be configured to provide the crash information to the second controller and to the third controller. The crash information provided to the second controller may be substantially identical to the crash information provided to the controller. The third controller may be configured to receive the crash information from the first controller and/or control operation of the plurality of safety devices of the second support assembly according to the crash information. The plurality of safety devices of the support assembly may include at least three safety devices. The plurality of safety devices of the second support assembly may include at least three safety devices. A track assembly may include a first track and a second track. The support assembly may be connected to the first track and the second track. The second support assembly may be connected to the first track and the second track.

In examples, a vehicle may include an electrical assembly and/or a mounting surface. The first controller may be fixed (e.g., directly or indirectly) relative to the mounting surface. The support assembly may include a first seat. The plurality of safety devices of the support assembly may be configured to restrict movement of an occupant of the first seat. The second support assembly may include a second seat. The plurality of safety devices of the second support assembly may be configured to restrict movement of an occupant of the second seat.

With examples, a first controller may be connected to a vehicle sensor. Crash information may correspond, at least in part, to information from the vehicle sensor. The first controller and the second controller may be configured to communicate via a wired connection through the track assembly and via a wireless connection. Controlling the plurality of safety devices may include determining which safety devices of the plurality of safety devices to activate and activating the plurality of safety devices. The second controller may be configured to activate the plurality of safety devices via a preprogrammed time sequence.

In examples, a method of operating an electrical assembly may include providing, via a first controller fixed to a vehicle, the same crash information to a plurality of other controllers connected to respective support assemblies configured for selective connection with a track assembly of the vehicle. The method may include controlling, via the plurality of other controllers, operation of (i) a first plurality of safety devices associated with a first support assembly of the respective support assemblies, and/or (ii) a second plurality of safety devices associated with a second support assembly of the respective support assemblies. The crash information may not include an activation command or signal for the first plurality of safety devices or the second plurality of safety devices. Controlling operation of the first plurality of safety devices may include obtaining information from a first sensor associated with the first support assembly and activating the first plurality of safety devices according to the crash information and the information from the first sensor. Controlling operation of the second plurality of safety devices may include obtaining information from a second sensor associated with the second support assembly and activating the second plurality of safety devices according to the crash information and the information from the second sensor. The first controller may provide the same crash information to the plurality of other controllers via a first wireless connection and a second wireless connection.

The foregoing and other potential aspects, features, details, utilities, and/or advantages of examples/embodiments of the present disclosure will be apparent from reading the following description, and from reviewing the accompanying drawings.

### BRIEF DESCRIPTION OF THE DRAWINGS

FIG. 1 is a side view generally illustrating an embodiment of an electrical assembly according to teachings of the present disclosure.

FIG. 2 is a section view generally illustrating portions of an embodiment of an electrical assembly according to teachings of the present disclosure.

FIG. 3 is a diagram generally illustrating an embodiment of an electrical assembly according to teachings of the present disclosure.

FIG. 4 is a diagram generally illustrating an embodiment of an electrical assembly according to teachings of the present disclosure.

FIG. 5 is a flowchart generally illustrating an embodiment of a method of operating an electrical assembly according to teachings of the present disclosure.

### DETAILED DESCRIPTION

Reference will now be made in detail to embodiments of the present disclosure, examples of which are described herein and illustrated in the accompanying drawings. While the present disclosure will be described in conjunction with embodiments and/or examples, it will be understood that they do not limit the present disclosure to these embodiments and/or examples. On the contrary, the present disclosure covers alternatives, modifications, and equivalents.

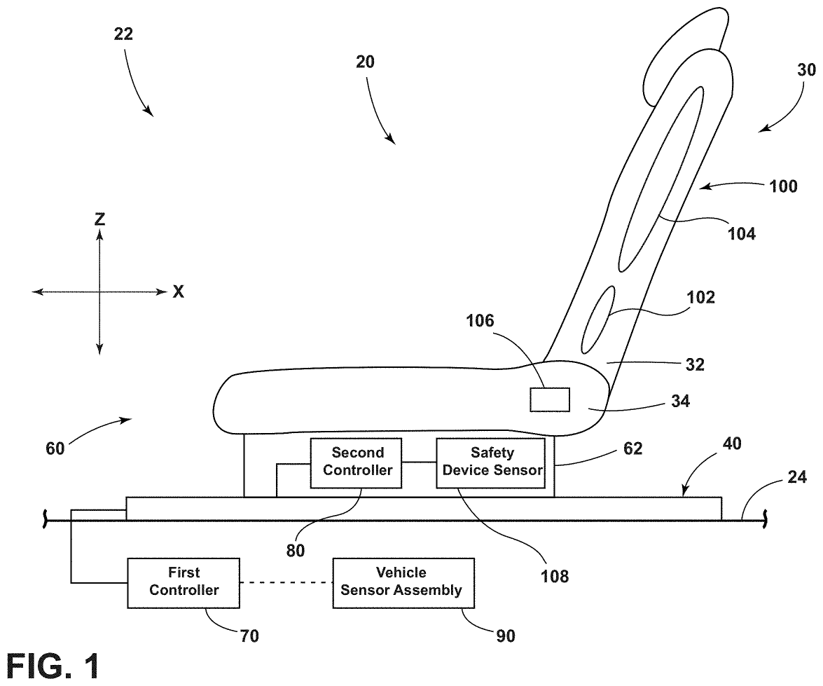

In embodiments, such as generally illustrated in FIG. 1, an electrical assembly 20 may include a track assembly 40 and/or a support assembly 60. The support assembly 60 may include a support member 62 and/or a seat 30. The support member 62 may be configured to support a seat 30 and may be configured to move (e.g., slide, roll, translate, etc.) with the seat 30 along the track assembly 40. The electrical assembly 20 may be configured to control (e.g., activate/deactivate, transfer trigger pulses, etc.) and/or monitor various safety devices 100 within a vehicle 22. The electrical assembly 20 may activate various safety devices 100, such as if a crash event or imminent crash event is detected, and/or the electrical assembly 20 may monitor the operating status of various safety devices 100 at substantially all times. The electrical assembly 20 may, for example and without limitation, be disposed within and/or may be connected to a vehicle 22.

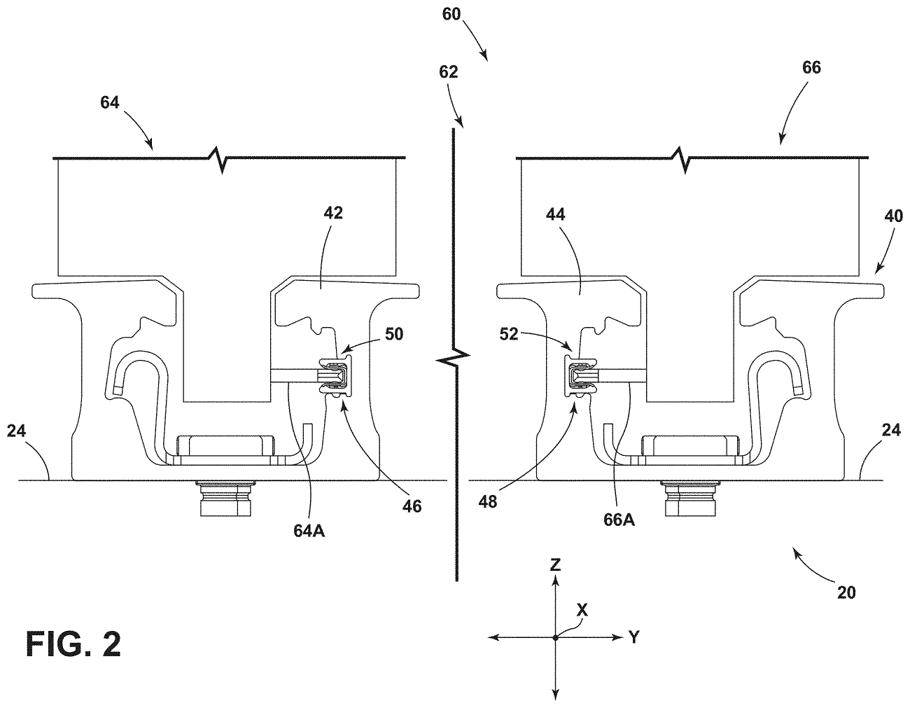

With embodiments, the electrical assembly 20 may include a track assembly 40. The track assembly 40 may include a first track 42 and/or a second track 44 (see, e.g., FIG. 2). The first track 42 and/or the second track 44 may be disposed on and/or connected to a mounting surface 24 (e.g., a vehicle floor). The first track 42 and/or the second track 44 may extend substantially in the X-direction. The first track 42 may be substantially parallel to the second track 44, and/or the first track 42 may be offset in the Y-direction from the second track 44. The first track 42 and/or the second track 44 may mechanically and/or electrically connect to a support assembly 60, such as to a support member 62 and/or a seat 30.

In embodiments, the track assembly 40 may include a first conductor 46 and/or a second conductor 48. The conductors 46, 48 may be electrically connected to a first controller 70. The first conductor 46 and/or the second conductor 48 may provide a wired connection between a first controller 70 and a second controller 80 (e.g., any number of controllers that may be selectively connectable to the track assembly 40). The conductors 46, 48 may be disposed within a side of the tracks 42, 44. The tracks 42, 44 may include recesses/apertures 50, 52 configured to at least partially receive the conductors 46, 48. The conductors 46, 48 may electrically connect the support assembly 60 (e.g., or various electrical components of the support assembly 60) to the first controller 70. The conductors 46, 48 may be configured to provide power and/or to send signals/data via the first track 42 and/or the second track 44 to the support assembly 60 from the first controller 70.

With embodiments, the support member 62 may be configured to support the seat 30 and/or one or more items or components that may be disposed on or connected to the seat 30, such as an occupant. The seat 30 may include a seat back 32 and/or a seat base 34. The support member 62 may mechanically support the seat 30 on the track assembly 40. The support member 62 and/or the seat 30 may be configured to move along the track assembly 40 substantially in the X-direction. A support assembly 60, which may include a seat 30 and/or a support member 62, may be configured to be selectively inserted into and/or selectively removed (e.g., completely) from the track assembly 40, such as in the Z-direction. The support assembly 60 may include, be connected to, and/or control/facilitate operation of one or more safety devices 100 (e.g., for an occupant of the seat 30), such as via the second controller 80 that may be connected to and/or disposed in the seat 30. A second controller 80 may be configured to transmit trigger pulses to the one or more safety devices 100. The support member 62 may include a first portion 64 and/or a second portion 66 that may be disposed opposite each other and may be configured for connection with the first track 42 and/or the second track 44. For example and without limitation, the first portion 64 may be connected to the first track 42 and the second portion 66 may be connected to the second track 44. Additionally or alternatively, the first portion 64 may be connected to the second track 44 and the second portion 66 may be connected to the first track 42. The first portion 64 may include a first contact 64A (e.g., an electrical contact), and/or the second portion 66 may include a second contact 66A. The first contact 64A may be configured to electrically connect to the first conductor 46 and/or the second conductor 48. The second contact 66A may be configured to electrically connect to the first conductor 46 and/or the second conductor 48.

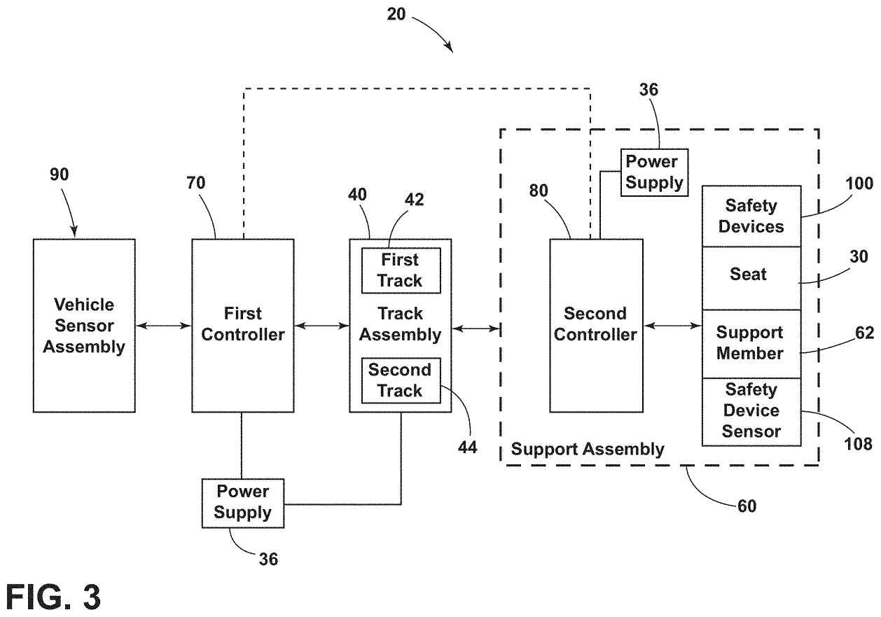

In embodiments, such as generally illustrated in FIG. 3, the first track 42 and/or the second track 44 may be electrically connected to the first controller 70 that may be disposed within the vehicle 22. The first controller 70 may not be disposed in the seat 30 and/or the support assembly 60. The first controller 70 may be electrically connected to the first track 42, the second track 44, and/or the seat 30 (e.g., to a second controller 80 of the seat 30). The first controller 70 may be configured for communication with the second controller 80. The first controller 70 may be electrically connected to the second controller 80 wirelessly and/or via a wired connection (e.g., via the track assembly 40).

With embodiments, the first controller 70 may include and/or may be configured to connect to a vehicle sensor assembly 90. The vehicle sensor assembly 90 may include one or more vehicle sensors 92. The vehicle sensors 92 may be configured to sense information about a crash event and/or a potential crash event. For example and without limitation, the vehicle sensors 92 may include proximity sensors, force sensors, acceleration sensors, radar, and/or Lidar, among others. The vehicle sensors 92 may be configured to sense a direction of impact, a severity of impact, and/or other vehicles and/or objects in proximity to the vehicle 22. The sensors 92 of the vehicle sensor assembly 90 may, for example and without limitation, be disposed about a perimeter of the vehicle 22 such as to predict and/or detect potential crash situations from some, any, and/or all directions. The sensors 92 of the sensor assembly 90 may, for example and without limitation, be disposed substantially proximate to the sides of the vehicle 22, the front of the vehicle 22, and/or the rear of the vehicle 22. The first controller 70 may be configured to receive information (e.g., data, signals, etc.) from the vehicle sensor assembly 90 to determine an impact zone for a potential collision and/or the first controller 70 may be configured to determine the direction and/or force of a potential collision.

In embodiments, an electrical assembly 20 may include a second controller 80. The second controller 80 may be disposed substantially in the seat 30 and/or the support assembly 60 (such as generally illustrated in FIG. 3). The second controller 80 may be configured to be fixed with the seat 30 such that removing the seat 30 from the track assembly 40 may disconnect the second controller 80 from the first controller 70 (e.g., when connected via a wired connection). The second controller 80 may be configured to control one or more safety devices 100 connected to the seat 30.

With embodiments, the second controller 80 may be connected to one or more safety devices 100. The safety devices 100 may include one or more of a variety of crash-activated safety devices. For example and without limitation, the safety devices 100 may include air bags and/or pretensioners. The safety devices 100 may include and/or be activated by pyrotechnics. For example and without limitation, the safety devices 100 may be configured to rapidly/instantly expand (e.g., an air bag may inflate with air/gas) upon activation. The safety devices 100 may be configured to be activated by a signal (e.g., a deployment current pulse) that may be transmitted by the first controller 70. The one or more safety devices 100 may include a first safety device 102, a second safety device 104, a third safety device 106, and/or one or more other safety devices (e.g., safety devices 100 may include at least two safety devices, at least three safety devices, and/or other numbers of safety devices). A first safety device 102 and/or a second safety device 104 may, for example, be disposed at least partially in the seat back 32 and/or the seat base 34. The first safety device 102 and/or the second safety device 104 may be disposed proximate the seat 30 such as to contact and/or limit movement of an occupant when activated.

In embodiments, the second controller 80 may be connected to one or more safety device sensors 108. The one or more safety device sensors 108 may be configured for obtaining information about, reading, and/or determining the status of one or more safety devices 100, such as the first safety device 102 and/or the second safety device 104. The one or more safety device sensors 108 may be configured to determine occupancy of a seat 30 and/or a seat belt status. If a safety device sensor 108 indicates that a safety device 100 is not in an operating condition, the second controller 80 may communicate to the first controller 70, which may provide an alert to the vehicle 22 and/or a passenger. The second controller 80 may receive the signal from the first controller 70 and/or the second controller 80 may not activate the safety devices 100 without receiving feedback/information from one or more safety device sensors 108. In determining which safety devices 100 to activate, the second controller 80 may utilize information received by the vehicle sensor assembly 90 (which may be communicated to the second controller 80 by the first controller 70) and/or information received by the one or more safety device sensors 108.

With embodiments, the first controller 70 may be configured to communicate with the second controller 80 in one or more of a variety of ways. For example and without limitation, the first controller 70 may be configured to communicate with the second controller 80 via one or more wired/physical connections (e.g., via power line communication (PLC)) and/or via one or more wireless connections. Wireless communication may, for example and without limitation, include inductive coupling, infrared light transmission, and/or DC magnetic field generation and detection, among others. The first controller 70 may be configured to receive information from the vehicle sensor assembly 90, and/or the first controller 70 may transmit crash information to the second controller 80. The first controller 70 may or may not be configured to directly activate safety devices 100, such as the first safety device 102 and/or the second safety device 104. The crash information may, for example and without limitation, include information regarding the source, direction, and/or severity of a crash and may not include activation signals or commands (or the like) for activating/igniting safety devices 100. The second controller 80 may be configured to activate the safety devices 100 upon receiving crash information from the first controller 70, such as if the crash information indicates that a crash is imminent and/or has occurred.

In embodiments, the first controller 70 may be configured to transmit information to the second controller 80, and/or the second controller 80 may be configured to receive the information from the first controller 70. The second controller 80 may receive the information from the first controller 70 that may indicate a direction of projected collision, and/or the signal may include a projected magnitude of collision (e.g., the first controller 70 may determine the speed at which another vehicle is approaching the vehicle 22 or vice versa). The first controller 70 may be configured to transform information from the sensor assembly 90 into information that may be utilized by the second controller 80 in determining how (or if) to activate safety devices 100. The first controller 70 may be configured to send the transformed information to the second controller 80. The second controller 80 may evaluate the information received from the first controller 70 and determine which safety devices 100 to activate and/or an order/timing of activation. The second controller 80 may include one or more predetermined sequences for activating safety devices 100. For example and without limitation, based on the information received from the first controller 70 and the information from the one or more safety device sensors 108, the second controller 80 may select a predetermined sequence for triggering the safety devices 100.

In embodiments, an electrical assembly 20 may include one or more additional controllers, such as a third controller 110, that may be configured in the same or a similar manner as the second controller 80. The third controller 110 may be disposed at least partially and/or connected to a second support assembly 160. The second support assembly 160 may include the same or a similar configuration as the support assembly 60 and may include a second seat 112, one or more safety devices 114, and/or one or more safety device sensors 122. The second support assembly 160 may be connected to the track assembly 40 in a substantially similar manner as the seat 30 (e.g., may be configured to be vertically removed from the track assembly 40 and/or may be configured to move along the track assembly 40). The third controller 110 may be connected (e.g., via one or more wireless connections and/or wired connections) to the first controller 70. The second seat 112 may include one or more safety devices 114. For example and without limitation, the second seat 112 may include a first safety device 116, a second safety device 118, and/or a third safety device 120 (or other numbers of safety devices). The third controller 110 may be connected to and/or may include one or more safety device sensors 122 that may be configured to monitor and/or provide feedback regarding the first safety device 116, the second safety device 118, and/or the third safety device 120. The one or more safety device sensors 122 may be configured to transmit information regarding the status of the safety devices 114 to the third controller 110. The third controller 110 may evaluate the information from the safety device sensors 122 before activating the first safety device 116, the second safety device 118, and/or the third safety device 120.

With embodiments, the third controller 110 may be configured to receive information from the first controller 70 and/or information from the safety device sensors 122. The third controller 110 may determine which safety devices 114 to activate and/or the order of activation according to information from the first controller 70, which may correspond to information from the vehicle sensor assembly 90, and/or according to the safety device sensors 122. The first controller 70 may be configured to transmit the same information to substantially any number of support assemblies (e.g., support assemblies 60, 160) that may be connected to the track assembly 40 and/to substantially any number of controllers (e.g., controllers 80, 110) connected to the first controller 70. For example and without limitation, the first controller 70 may transmit the same information to the second controller 80 and the third controller 110. The second controller 80 may activate different safety devices 100 than the third controller 110 depending on the information received from the first controller 70. The second controller 80 and the third controller 110 may be configured to independently control the respective one or more safety devices 100, 114. Although the first controller 70 may transmit crash/potential collision information to the second controller 80 and/or the third controller 110, the first controller 70 may not be configured to directly activate and/or control the safety devices 100, 114 of the support assemblies 60, 160.

In examples, transmitting the same information to a plurality and/or all support assemblies 60, 160 may reduce the number of connections between the first controller 70 and the support assemblies 60, 160. For example and without limitation, without other designs, a central, fixed controller may directly activate each safety device, which may involve providing a physical connection between the central controller and each safety device. Such as configuration may not be practical with some configurations, such as with removable support assemblies or seats having multiple safety devices. For example, if two support assemblies each having a seat with three safety devices were connected to the same tracks, the central controller may use six connections (e.g., at least six electrical contacts) for controlling the safety devices. However, there may not be sufficient space for six electrical contacts and/or tracks/support assemblies with six electrical contacts may be undesirably large, complex, and/or expensive.

With examples, an electrical assembly 20 may be configured for wireless communication of information from the first controller 70 to one or more other controllers 80, 110. Wireless communication may be utilized in addition to or instead of wired communication. For example, some embodiments may be configured for a combination of wired and wireless communication. Additionally, some embodiments may be configured for wireless communication without material wired communication. With such embodiments, wireless communication between the first controller 70 and the one or more other controllers 80, 110 may be conducted via one or more technologies. For example and without limitation, wireless communication between the first controller 70 and the one or more other controllers 80, 110 may be conducted with at least two different technologies, such as to provide redundancy. Wireless communication may include, for example and without limitation, inductive coupling, visible/infrared light transmission (e.g., via one or a plurality of wavelengths), radio frequency identification (RFID), and/or DC magnetic field generation and detection, among others.

In an example, an electrical assembly 20 may include a plurality of antennas 170 that may be configured inductive coupling at a plurality of frequencies (e.g., 125 kHz or similar and 13.56 MHz or similar). The one or more antennas 170 may, for example, be configured as RFID loop antennas. The first controller 70 may transmit crash information to the one or more other controllers 80, 110 via the one or more antennas 170.

In an example, an electrical assembly 20 may include an antenna 170 and a light source 180 that may be configured to transmit information (e.g., the same crash information) to the one more other controllers 80, 110. For example and without limitation, the antenna 170 may be configured inductive coupling and the light source 180 may be configured to provide light to a light guide of the track assembly 40. The support assemblies 60, 160 may be configured to sense the light and extract the crash information from the light.

In an example, an electrical assembly 20 may include an antenna 170 and a magnetic field generator 190A (e.g., solenoids) that may be configured to transmit information (e.g., the same crash information) to the one more other controllers 80, 110. For example and without limitation, the antenna 170 may be configured inductive coupling and the generator 190A may be configured to generate a magnetic field that may be sensed by detectors 190B of the support assemblies 60, 160. The support assemblies 60, 160 may be configured to extract the crash information from the detected magnetic field.

In examples, the first controller 70 may be configured to communicate with one or more other controllers 80, 110 via a wireless connection, such as for diagnostic information. A diagnostic wireless connection may be separate from and in addition to any wireless connections that may be utilized for communicating crash information (e.g., an electrical assembly 20 may be configured for three or more wireless connections in at some configurations).

With examples, a first controller 70 of an electrical assembly 20 may be configured to encapsulate crash information prior to transmitting the crash information to one or more other controllers 80, 110, and/or the one or more other controllers 80, 110 may be configured to decapsulate the crash information.

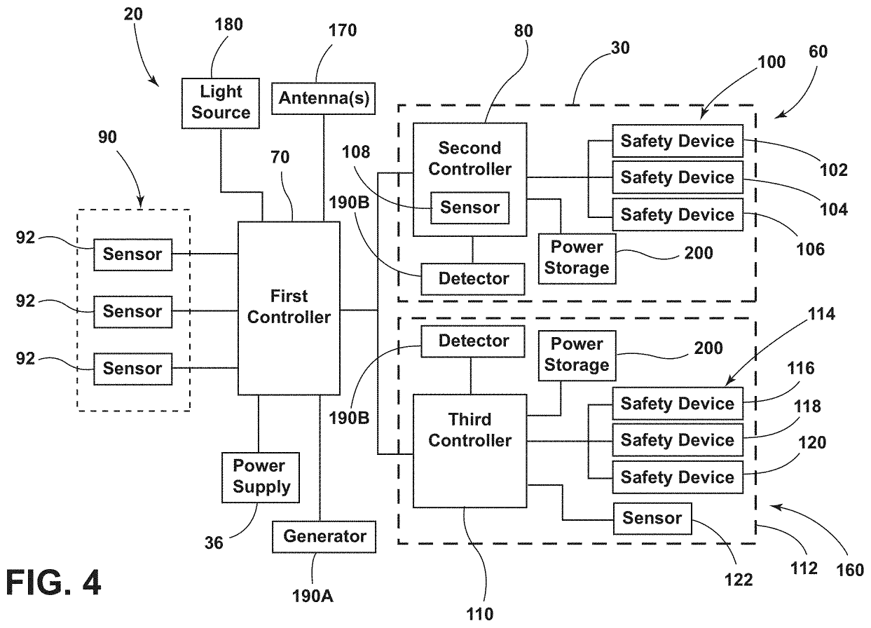

In examples, such as generally illustrated in FIG. 4, an electrical assembly 20 may include one or more supplemental power storage devices (e.g., batteries) 200. For example and without limitation a support assembly 60, 160 may include power storage device 200 that may be configured to provide power to the one or more other controllers 80, 110 to operate the one or more other controllers 80, 110 if the support assembly 60, 160 is not connected to a power supply 36 (e.g., if the support assembly 60, 160 is disconnected during a crash). Additionally or alternatively, the power storage devices 200 may be configured to provide power for activating the safety devices 100, 114. While a support assembly 60, 160 is connected to a track assembly 40, the power supply 36 may charge and/or maintain the charge of the power storage devices 200.

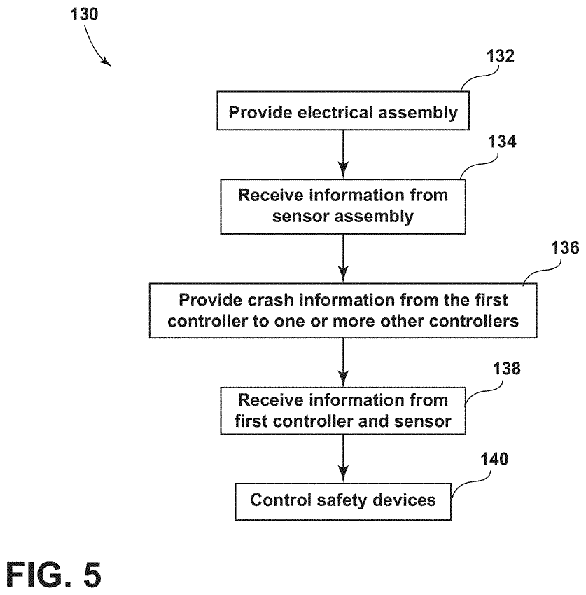

In embodiments, such as generally illustrated in FIG. 5, a method 130 of operating an electrical assembly 20 may include providing an electrical assembly 20 (step 132). An electrical assembly 20 may include a first controller 70, a vehicle sensor assembly 90, and/or one or more support assemblies 60, 160. The method 130 may include the first controller 70 receiving information from the vehicle sensor assembly 90 that may indicate a collision or potential collision (step 134). The method 130 may include the first controller 70 collecting the information from the sensor assembly 90 and providing crash information to one or more other controllers 80, 110 that may be associated with the one or more support assemblies 60, 160, such as a second controller 80 and/or a third controller 110. The first controller 70 may transmit the crash information via a track assembly 40 and/or one or more wireless connections (step 136). The method 130 may include the one or more other controllers 80, 110 receiving the crash information and/or information from a safety device sensor 108, 122 (step 138). The method 130 may include one or more other controllers 80, 110 controlling the one or more safety devices 100, 114 (step 140), which may include determining whether to activate certain safety devices 100, 114, determining when to activate safety devices 100, 114 (e.g., an activation sequence), and/or activating some or all safety devices 100, 114.

In examples, a controller (e.g., controllers 70, 80, 110) may include an electronic controller and/or include an electronic processor, such as a programmable microprocessor and/or microcontroller. In embodiments, a controller may include, for example, an application specific integrated circuit (ASIC). A controller may include a central processing unit (CPU), a memory (e.g., a non-transitory computer-readable storage medium), and/or an input/output (I/O) interface. A controller may be configured to perform various functions, including those described in greater detail herein, with appropriate programming instructions and/or code embodied in software, hardware, and/or other medium. In embodiments, a controller may include a plurality of controllers. In embodiments, a controller may be connected to a display, such as a touchscreen display.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

All matter contained in the above description or shown in the accompanying drawings shall be interpreted as illustrative only and not limiting. Changes in detail or structure may be made without departing from the present disclosure.

It should be understood that an electronic control unit (ECU) or controller, a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. An electrical assembly, including:
a first controller;
a track assembly; and
a support assembly configured for selective connection with the track assembly, the support assembly including:
a second controller;
a sensor; and
one or more safety devices;
wherein the first controller is configured to provide crash information to the second controller; and the second controller is configured control the one or more safety devices according to the crash information and information from the sensor.

2. The electrical assembly of claim 1, wherein the first controller is connected to the second controller via at least two wireless connections.

3. The electrical assembly of claim 2, wherein the at least two wireless connections include at least one of induction coupling, magnetic field generation and detection, RF generation and detection, and light transmission.

4. The electrical assembly of claim 1, wherein the first controller is configured to provide the crash information to the second controller only via one or more wireless connections.

5. The electrical assembly of claim 1, including a second support assembly configured for selective connection with the track assembly.

6. The electrical assembly of claim 5, wherein the second support assembly includes a third controller and one or more other safety devices.

7. The electrical assembly of claim 6, wherein the first controller is configured to provide the crash information to the second controller and to the third controller; and the crash information provided to the second controller is substantially identical to the crash information provided to the third controller.

8. The electrical assembly of claim 6, wherein the third controller is configured to receive the crash information from the first controller and control operation of the one or more other safety devices of the second support assembly according to the crash information.

9. The electrical assembly of claim 6, wherein the one or more safety devices of the support assembly includes at least three safety devices; and the one or more other safety devices of the second support assembly includes at least three other safety devices.

10. The electrical assembly of claim 5, wherein the track assembly includes a first track and a second track; the support assembly is connected to the first track and the second track; and the second support assembly is connected to the first track and the second track.

11. A vehicle, comprising:
the electrical assembly of claim 5; and
a mounting surface;
wherein the first controller is fixed to the mounting surface;
wherein the support assembly includes a first seat and the plurality of safety devices of the support assembly are configured to restrict movement of an occupant of the first seat; and
wherein the second support assembly includes a second seat and the plurality of safety devices of the second support assembly are configured to restrict movement of an occupant of the second seat.

12. The electrical assembly of claim 1, wherein the first controller is connected to a vehicle sensor; and the crash information corresponds, at least in part, to information from the vehicle sensor.

13. The electrical assembly of claim 1, wherein the first controller and the second controller are configured to communicate via a wired connection through the track assembly and via a wireless connection.

14. The electrical assembly of claim 1, wherein controlling the plurality of safety devices includes determining which safety devices of the plurality of safety devices to activate and activating the plurality of safety devices.

15. The electrical assembly of claim 14, wherein the second controller is configured to activate the plurality of safety devices via a preprogrammed time sequence.

16. A method of operating an electrical assembly, the method comprising:
providing, via a first controller fixed to a vehicle, the same crash information to a one or more other controllers connected to respective support assemblies configured for selective connection with a track assembly of the vehicle;
controlling, via the one or more other controllers, operation of (i) one or more safety devices associated with a first support assembly of the respective support assemblies, and (ii) one or more other safety devices associated with a second support assembly of the respective support assemblies.

17. The method of claim 16, wherein the crash information does not include an activation command or signal for the one or more safety devices or the one or more other safety devices.

18. The method of claim 16, wherein controlling operation of the one or more safety devices includes obtaining information from a first sensor associated with the first support assembly and activating the one or more safety devices according to the crash information and the information from the first sensor.

19. The method of claim 16, wherein controlling operation of the one or more other safety devices includes obtaining information from a second sensor associated with the second support assembly and activating the one or more other safety devices according to the crash information and the information from the second sensor.

20. The method of claim 16, wherein the first controller provides the same crash information to the one or more other controllers via a first wireless connection and a second wireless connection.
